(19) United States
(12) Patent Application Publication
(10) Pub. No.: US 2016/0350846 A1
(43) Pub. Date: Dec. 1, 2016

(54) INTEGRATED FINANCIAL AND HEALTH MONITORING SYSTEM UTILIZING WEARABLE DEVICES

(71) Applicant: Bank of America Corporation, Charlotte, NC (US)

(72) Inventors: Katherine Dintenfass, Charlotte, NC (US); David M. Grigg, Rock Hill, SC (US); Alicia C. Jones-McFadden, Fort Mill, SC (US); Jeanne Ferullo Connolly, Braintree, MA (US); Craig Terrill, Barrington Hills, IL (US); Sahil Bahri, Chicago, IL (US); Sonny Tai, Chicago, IL (US); Markondapatnaikuni Samba Siva Patnaik, Chicago, IL (US)

(21) Appl. No.: 14/723,288

(22) Filed: May 27, 2015

(51) Int. Cl. G06Q 40/00; G06F 19/00

(52) U.S. Cl. CPC G06Q 40/00; G06F 19/3406

(57) ABSTRACT

Embodiments of the invention are directed to systems, methods, and computer program products for a system that utilizes health information (e.g., steps taken, miles walked, exercise time, strenuous activity, pulse, heart rate, sweat analysis, breath analysis, blood analysis, caloric intake, skin analysis, temperature analysis, brainwave analysis, other medical diagnostic information, or the like) captured from wearable devices, and financial transactions to adjust estimated or projected life expectancy and health expenses (e.g., medical care expenses, fitness care expenses, health food expenses, or the like) of a user, in order to adjust retirement age, retirement savings, or other financial information, and display this information in a financial, health, and/or retirement monitoring interface.

### FIELD

Embodiments of the invention relate to improving user health and financial planning, in particular, embodiments of the invention relate to a system for monitoring health information through a wearable device, as well as financial transactions, and providing financial, health, and retirement feedback to the user.

### BACKGROUND

Monitoring a user's health has become an important feature of a user's fitness. Different types of wearable devices have been used to monitor the health of a user in various ways; however, utilizing the health information captured from wearable devices in meaningful ways is still a limited area.

### BRIEF SUMMARY

Embodiments of the present invention address the above needs and/or achieve other advantages by providing apparatuses (e.g., a system, computer program product, and/or other device) and methods for a system that utilizes health information (e.g., steps taken, miles walked, exercise time, strenuous activity, pulse, heart rate, sweat analysis, breath analysis, blood analysis, caloric intake, skin analysis, temperature analysis, brainwave analysis, other medical diagnostic information, or the like) captured from wearable devices, and financial transactions to adjust estimated or projected life expectancy and health expenses (e.g., medical care expenses, fitness care expenses, health food expenses, or the like) of a user, in order to adjust retirement age, retirement savings, or other financial information, and display this information in a financial, health, and/or retirement monitoring interface.

Embodiments of the invention comprise systems, computer program products, and methods for utilizing health information captured by a wearable device and financial transaction information to provide retirement feedback to the user. The embodiments of the present invention comprise monitoring the financial transactions of a user; monitoring the health of the user by receiving the health information captured by the wearable device associated with the user; determining a projected life expectancy of the user; determining a projected allocation of heath expenses for the user based on the financial transactions monitored and the health information captured by the wearable device; and displaying the projected life expectancy of the user and the projected allocation of the health expenses to the user in a financial, health, and retirement monitoring interface through a user computer system or through the wearable device.

In further accord with embodiments of the invention, the present invention receives a request from the user to utilize the financial, health, and retirement monitoring system; determines an initial projected life expectancy of the user based on user profile information, and determines an initial projected allocation of heath expenses of the user based on historical financial transactions.

In other embodiments of the invention, the financial transactions of the user are monitored in real-time or near real-time, and the health information is captured by the wearable device and received in real-time or near real-time.

In still other embodiments of the invention, the invention further comprises determining a new retirement age and retirement funds based on the projected life expectancy of the user and the projected allocation of heath expenses for the user; and displaying the new retirement age and the retirement funds to the user in the financial, health, and retirement monitoring interface.

In yet other embodiments of the invention, the invention further comprises determining a suggested financial transaction to improve the projected life expectancy of the user and the projected allocation of heath expenses for the user; and displaying the suggested financial transaction to the user in the financial, health, and retirement interface.

In other embodiments of the invention, the invention further comprises determining a suggested action to improve the projected life expectancy of the user and the projected allocation of heath expenses of the user; and displaying the suggested action to the user in the financial, health, and retirement monitoring interface.

In still other embodiments of the invention, the financial, health, and retirement monitoring interface illustrates the change in health expenses and life expectancy per each transaction and action, per a category of transactions and actions, and as a total for all transactions and actions.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will be made to the accompanying drawings, where:

FIG. 1 presents a block diagram of the financial, health, and retirement monitoring system environment for implementing the process flows described herein, in accordance with embodiments of the present invention;

FIG. 2 illustrates a block diagram of a mobile device user computer system for the financial and health monitoring system environment for implementing the process flows described herein, in accordance with embodiments of the present invention;

FIG. 3 illustrates a process flow for monitoring user financial transactions and user health information for providing financial, health, and/or retirement feedback, in accordance with embodiments of the present invention; and

FIG. 4 illustrates a financial, health, and/or retirement monitoring interface, in accordance with embodiments of the present invention.

### DETAILED DESCRIPTION OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

In some embodiments, a “user” may be a financial institution customer (e.g., an account holder or a person who has an account, such as but not limited to a banking account, credit account, retirement account, investment account, or utilizes any other type of good or services (hereinafter product) from the financial institution). In one aspect with respect to retirement accounts, a user may be any financial institution customer involved in retirement planning with the financial institution or any other affiliate entities associated with the financial institution. In some embodiments, the user may be an individual who may be interested in opening an account with the financial institution. In some other embodiments, a user may be any individual who may be interested in enrolling in the retirement plan offered by the financial institution. For purposes of this invention, the term “user” and “customer” may be used interchangeably. In some embodiments, a “financial advisor” may be a financial institution employee (e.g., an underwriter, a project manager, an IT specialist, a manager, an administrator, an internal operations analyst, bank teller, wealth management advisor, investment advisor, specialist, call center representative, banking associate, or the like) that is associated with the systems described herein, or other systems.

In some embodiments, an “entity” as used herein may be a financial institution. For the purposes of this invention, a “financial institution” may be defined as any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. In some embodiments, the entity may allow a user to establish an account with the entity. An “account” may be the relationship that the user has with the entity. Examples of accounts include a deposit account, such as a transactional account (e.g. a banking account), a savings account, an investment account, a money market account, a time deposit, a demand deposit, a pre-paid account, a credit account, a wealth management account, a non-monetary user profile account that includes only personal information associated with the user, or the like. The account is associated with and/or maintained by an entity or affiliate of the entity. In other embodiments, an “entity” may not be a financial institution.

As used herein, a “user interface” may be a graphical user interface. Typically, a graphical user interface (GUI) is a type of interface that allows users to interact with electronic devices such as graphical icons and visual indicators such as secondary notation, as opposed to using only text via the command line. In some embodiments, the graphical user interface may include both graphical elements and text elements.

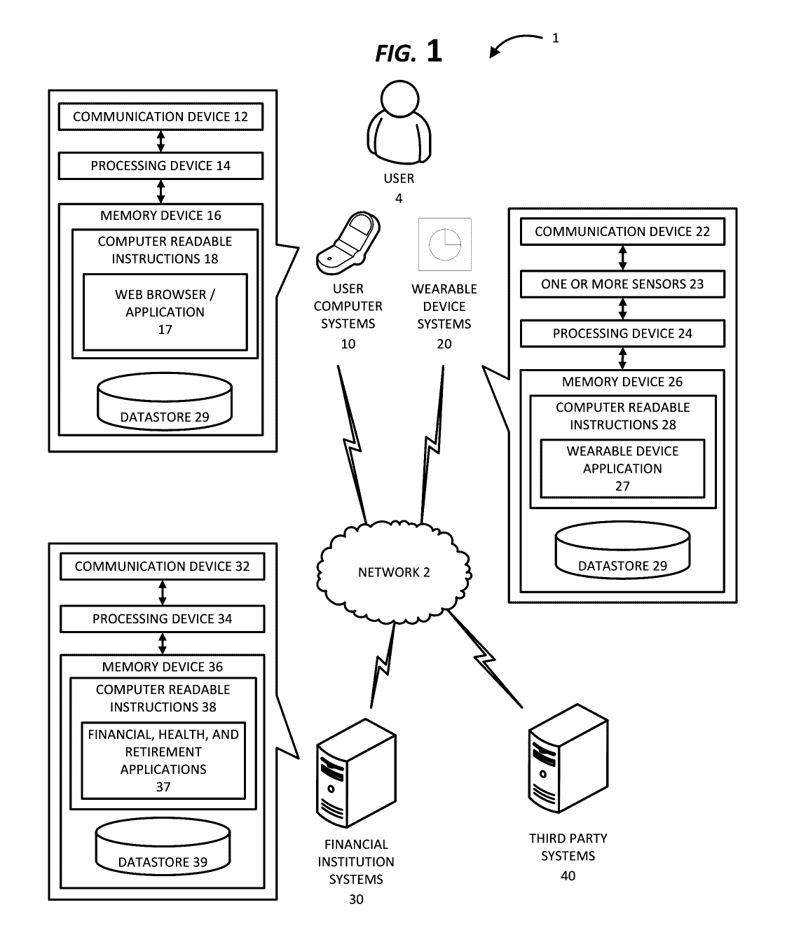

FIG. 1 presents an exemplary block diagram of the financial, health, and retirement monitoring system environment 1 for implementing the process flows described herein in accordance with embodiments of the present invention. As illustrated in FIG. 1, one or more user computer systems 10 are operatively coupled, via a network 2, to one or more wearable device systems 20, one or more financial institution systems 30, one or more third-party systems 40, and/or one or more other systems. In this way a user 4 may utilize the user computer systems 10 to access the wearable device application 27, the financial, health, and/or retirement applications 37, and/or other applications on the wearable device systems 20, financial institution systems 30, third-party systems 40, and/or other systems to provide and receive financial, health, and/or retirement feedback over the financial, health, and retirement monitoring system environment 1. In some embodiments of the invention the user computer systems 10, wearable device systems 20, financial institution systems 30, third-party systems 40, and/or other systems may store financial account applications, health applications, retirement applications, or the like, and information related to each in order to satisfy the processes and embodiments of the invention described herein.

The network 2 may be a global area network (GAN), such as the Internet, a wide area network (WAN), a local area network (LAN), or any other type of network or combination of networks. The network 2 may provide for wireline, wireless, or a combination of wireline and wireless communication between devices on the network 2.

As illustrated in FIG. 1, the user computer systems 10 generally comprise a communication device 12, a processing device 14, and a memory device 16. The user computer system 10 may be a desktop, laptop, tablet, mobile device (e.g., smartphone device), or any other type of computer that generally comprises a communication device 12, a processing device 14, and a memory device 16. The processing device 14 is operatively coupled to the communication device 12 and the memory device 16. As used herein, the term “processing device” generally includes circuitry used for implementing the communication and/or logic functions of a particular system. For example, a processing device 14 may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device 14 may include functionality to operate one or more software programs based on computer-readable instructions 18 thereof, which may be stored in a memory device 16.

The processing device 14 uses the communication device 12 to communicate with the network 2 and other devices on the network 2, such as, but not limited to, the wearable device systems 20, the financial institution systems 30, third-party systems 40, and/or other like systems. As such, the communication device 12 generally comprises a modem, server, or other device for communicating with other devices on the network 2, and/or a keypad, keyboard, touch-screen, display, touchpad, microphone, mouse, joystick, other pointer device, button, soft key, and/or other input or output device(s) for communicating with the user 4

As further illustrated in FIG. 1, the user computer systems 10 comprise computer-readable instructions 18 stored in the memory device 16, which in one embodiment includes the computer-readable instructions 18 of a web browser and/or application 17. In some embodiments, the memory device 16 includes a datastore 19 for storing data related to the financial institution systems 10, including, but not limited to, data created and/or used by the web browser and/or application 17.

The web browser/application 17 may be an application that allows the user 4 to access websites over a distributed network of systems (e.g., servers), such as the Internet or an intranet. The application 17 may also be a dedicated application for a computer or mobile device that allows the user 4 to access information over the distributed network of systems (e.g., servers), such as the Internet or an intranet.

As illustrated in FIG. 1, the wearable device systems 20 generally comprise a communication device 22, one or more sensors 23, a processing device 24, and a memory device 26. The processing device 24 is operatively coupled to the communication device 22, the one or more sensors 23, and the memory device 26. The processing device 24 uses the communication device 22 to communicate with the network 2 and other devices on the network 2, such as, but not limited to, the user computer systems 10, the financial institution systems 30, the third-party systems 40, and/or other systems. As such, the communication device 22 generally comprises a modem, server, or other device for communicating with other devices on the network 2 and/or a keypad, keyboard, touch-screen, display, touchpad, microphone, mouse, joystick, other pointer device, button, soft key, and/or other input or output device(s) for communicating with the user 4.

As illustrated in FIG. 1, the wearable device systems 20 may have computer-readable instructions 28 stored in the memory device 26, which in one embodiment includes the computer-readable instructions 28 of a wearable device application 27 that allows the user 4 to capture, track, and monitor, health information of the user, and transmit the health information to other systems, such as but not limited to the user computer systems 10, the financial institution systems 30, the third-party systems 40, and/or other systems. In some embodiments, the memory device 26 includes a datastore 29 for storing data related to the wearable device systems 20, including but not limited to data created, received, and/or used by the wearable device application 27.

The wearable device systems 20 may be a watch, band (e.g., wrist, chest, arm, neck, stomach, leg, or other like band), device in an item of clothing, insert into an item of clothing (e.g., into a hat, shoe, shirt, or the like), device that mounts to the user 4 or item of clothing on the user 4, or any other like device that the user 4 can wear. The wearable device system 20 may be a part of the user computer systems 10, such as an extension of the user computer systems 10 or it may be a separate wearable device system 10 that is configured to communicate with the user computer systems 10. The wearable device system 10 may or may not have a display or other communication device through which information may be presented to, or received by the user 4. The wearable device systems 20 may also comprise one or more sensor(s) 23 that may be used to monitor heath information (e.g., previously described as steps taken, miles walked, exercise time, strenuous activity, pulse, heart rate, sweat analysis, breath analysis, blood analysis, caloric intake, skin analysis, temperature analysis, brainwave analysis, other medical diagnostic information, or the like) about the health of the user 4, and use the health information captured by the sensors to determine or predict, or analyze heart issues, strokes, dehydration, emotional state, proper exercise form, or other diet information, diseases, conditions, or overall health based on the information captured from the wearable device. These sensors 23 monitoring a user 4 may provide information that can be used to adjust the life expectancy of the user 4 and estimate health expenses in the future.

As illustrated in FIG. 1, the financial institution systems 30 generally comprise a communication device 32, a processing device 34, and a memory device 36. The processing device 34 is operatively coupled to the communication device 32 and the memory device 36. The processing device 34 uses the communication device 32 to communicate with the network 2 and other devices on the network 2, such as, but not limited to, the user computer systems 10, the wearable device systems 20, third-party systems 40, and/or other systems. As such, the communication device 32 generally comprises a modem, server, or other device for communicating with other devices on the network 2.

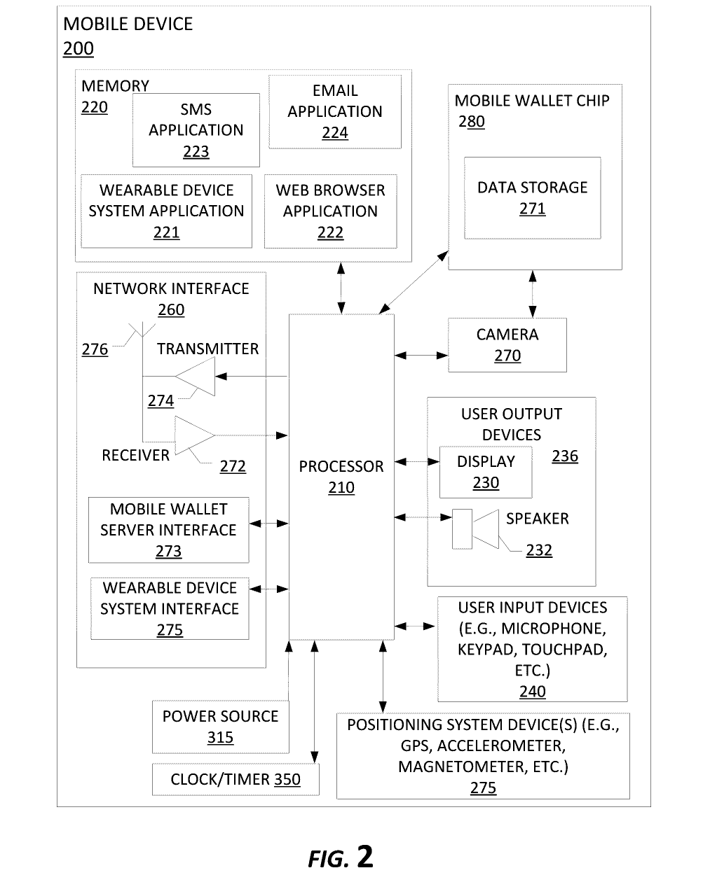

As further illustrated in FIG. 2, the financial institution systems 30 comprise computer-readable instructions 38 stored in the memory device 36, which in one embodiment includes the computer-readable instructions 38 of financial, health, and/or retirement applications 37. In some embodiments, the memory device 36 includes a datastore 39 for storing data related to the financial institution systems 30, including but not limited to data created and/or used by the financial, health, and/or retirement applications 37.

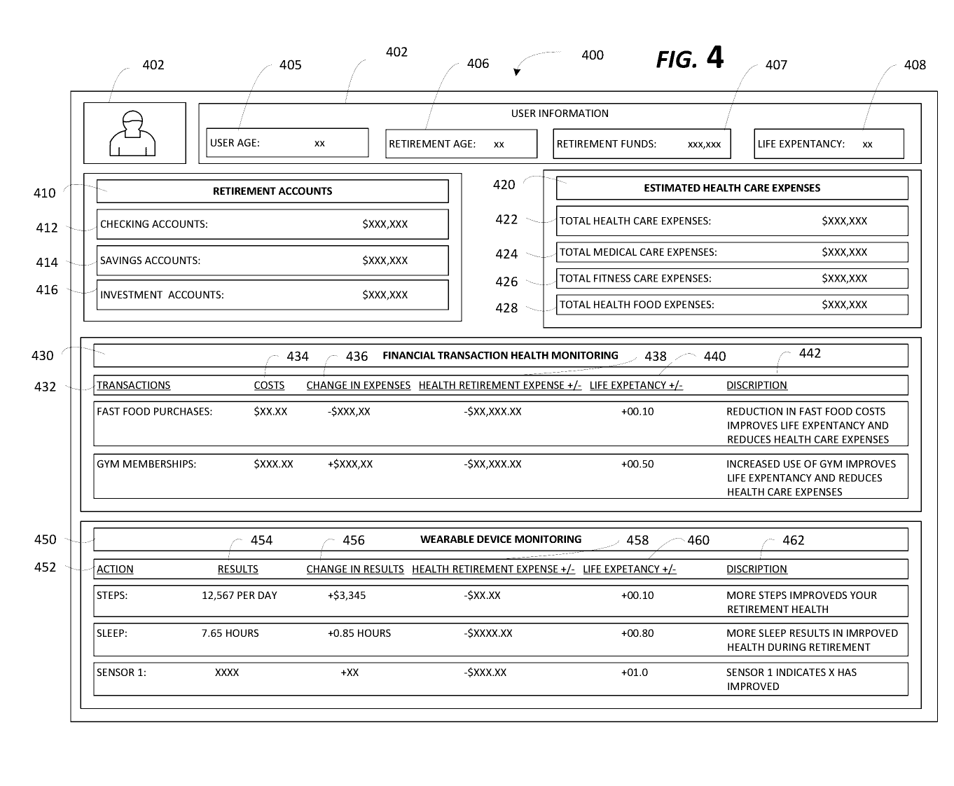

The financial, health, and/or retirement applications 37 may include information about the user's income, accounts, net worth, investments, personal user profile information (e.g., age, dependents, or the like), investment strategies, asset allocation, transaction information for historical purchases or purchases in real-time and/or near real-time, retirement information, health information (e.g., from the wearable device systems 20, or other systems that provide health information), or other like information. It should be understood that the financial, health, and retirement application may be described as any one of, or any combination of, a financial application, health application, and/or retirement application. As such, the functions described herein for the financial, health, and retirement application 37 may be performed by a single application or multiple applications working together. Moreover, the information described herein may be displayed in a financial, health, and retirement interface (described in further detail later). It should be understood that the interface may be described as any one of, or any combination of, a financial interface, health interface, and/or a retirement interface, and may be displayed in a single interface or multiple interfaces. An example of the financial, health, and retirement interface 400 is illustrated in FIG. 4.

The third-party systems 40 and/or other systems (not illustrated) are operatively coupled to the user computer systems 10, wearable device systems 20, the financial institution systems 30, and/or other systems, through the network 2. The third-party systems 40 and/or other systems have devices the same as or similar to the devices described for the user computer systems 10, the wearable device systems 20, and the financial institution systems 30 (e.g., communication device, processing device, memory device with computer-readable instructions, datastore, or the like). Thus, the third-party systems 40 and/or the other systems communicate with the user computer systems 10, the wearable device systems 20, and the financial institution systems 30, and/or each other in the same or similar way as previously described with respect to the user computer systems 10, the wearable device systems 20, and the financial institution systems 30. The third-party systems 40 and/or the other systems, in some embodiments, provide additional information that can be used by the financial, health, and retirement application 37 such as financial information from other financial institution to which the user 4 allows the financial institution to access, health information from other entities, such as entities that support the wearable device systems 20 or other entities that provide health related information, such as but not limited food and drink consumption tracking websites, systems that provide information related to average life expectancies, or the like.

In some embodiments of the invention one or more of the systems may be combined with each other, or otherwise perform the functions of the other systems described herein. In other embodiments of the invention one or more of the applications described herein may be combined with each other, or otherwise perform the functions of the other applications described herein. Furthermore, the applications may be any type of application, such as an application stored on a desktop, server, or other device, a mobile application stored on a mobile device, a cloud application, or other like application. As such, the applications described herein, or portions of the applications described herein may be stored and operated on any of the systems described herein. For example, a portion of the wearable device application 27 may be stored on the user computer systems 10, in order to achieve the invention described herein.

In addition, the various portions of the system environment 1 may be maintained for and/or by the same or separate parties. It will also be understood that the systems may include and/or implement any embodiment of the present invention described and/or contemplated herein. For example, in some embodiments, the systems are configured to implement any one or more of the embodiments of the process flows described and/or contemplated herein in connection any process flow described herein. Additionally, the systems are configured to initiate presentation of any of the user interfaces described herein.

FIG. 2 illustrates a block diagram of the user computer system 10 (e.g., a mobile device 200) for the financial, health, and retirement monitoring system environment 1 for implementing the process flows described herein. FIG. 2 illustrates an embodiment of a mobile device 200 that may be configured to allow users to make financial transactions and/or access the wearable device systems 20, financial institution systems 30, third-party systems 40, and/or other systems, including viewing the financial, health, and retirement interface 400 described herein. A “mobile device” 200 may be any mobile communication device, such as a cellular telecommunications device (i.e., a cell phone or mobile phone), personal digital assistant (PDA), smartphone, a mobile Internet accessing device, or other mobile device including, but not limited to portable digital assistants (PDAs), pagers, mobile televisions, gaming devices, laptop computers, tablet computers, cameras, video recorders, audio/video players, radios, GPS devices, and any combination of the aforementioned, or the like. In some embodiments, the mobile device 200 includes a wired or wireless connection to a communication device, such as an earpiece, stereo headset, or other communication device, wherein the communication device is configured to relay transaction information to the user. In a further embodiment, activation technology for the mobile device is embedded in a keychain, chip, bracelet, or other wearable device that can be conveniently carried by or worn by the user but is separate from the mobile device, such as a wearable device system 20 previously discussed.

The mobile device 200 may generally include a processor 210 communicably coupled to such components as a memory 220, user output devices 236, user input devices 240, a network interface 260, a power source 215, a clock or other timer 250, a camera 270, at least one positioning system device 275, one or more mobile wallet chips 280, etc. The processor 210, and other processors described herein, may generally include circuitry for implementing communication and/or logic functions of the mobile device 200. For example, the processor 210 may include a digital signal processor device, a microprocessor device, and various analog to digital converters, digital to analog converters, and/or other support circuits. Control and signal processing functions of the mobile device 200 may be allocated between these devices according to their respective capabilities. The processor 210 thus may also include the functionality to encode and interleave messages and data prior to modulation and transmission. The processor 210 may additionally include an internal data modem. Further, the processor 210 may include functionality to operate one or more software programs or applications, which may be stored in the memory 220. For example, the processor 210 may be capable of operating a connectivity program, such as a web browser and/or application 222. The web browser and/or application 222 may then allow the mobile device 200 to transmit and receive web content, such as, for example, location-based content and/or other web page content, according to a Wireless Application Protocol (WAP), Hypertext Transfer Protocol (HTTP), and/or the like.

The positioning system device 275 in the mobile device 200 may be configured to determine the orientation and velocity of the mobile device 200. For example, the positioning system device can be an accelerometer configured to determine the orientation and movement of the device. Similarly, the positioning system device 275 can be a magnetometer configured to determine the movement of the mobile device 200. The positioning system 275 may also be a global positioning system (e.g., GPS) that communicates with satellites or other systems for transmitting the position and direction of travel of the mobile device 200. In other embodiments, the positioning system device 275 is a level to determine orientation of the device; a compass to determine direction independent of the device; or an altimeter configured to determine the elevation of the device. Other types of positioning system devices 275 are possible and are configured to determine the location, orientation, and direction of movement over time of the mobile device 200.

The processor 210 may also be capable of operating applications, such as a wearable device system application 221, or a portion thereof, for communicating with a wearable device system 20 and receiving and transmitting health information from a wearable device system 20. The wearable device system application 221, or a portion thereof may be downloaded from a server and stored in the memory 220 of the mobile device 200.

Alternatively, the wearable device system application 221, or portion thereof, may be pre-installed and stored in a memory 220 of the mobile device 200 or operated directly from a website operably linked to the mobile device 200 through the network interface 260. In embodiments, where the wearable device system application 221, or portion thereof, is pre-installed or run from a website, the user may not need to download the wearable device system application 221, or portion thereof, from a server.

The mobile wallet chip 280 may include the necessary circuitry to provide the user 4 the ability to make purchases using the mobile device 200. Generally, the mobile wallet chip 280 will include data storage 271 which may include data associated with the financial accounts of the user, default settings, or other information for controlling transactions. The mobile wallet chip 280 and/or data storage 271 may be an integrated circuit, a microprocessor, a system-on-a-chip, a microcontroller, or the like.

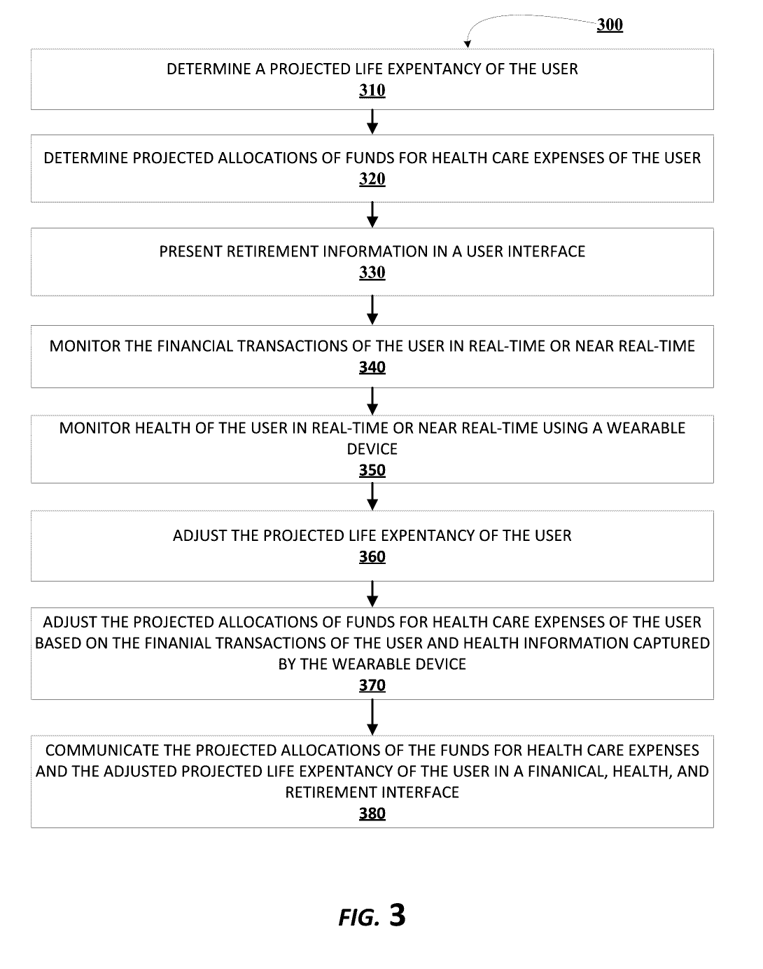

Of note, while FIG. 3 illustrates the mobile wallet chip 280 as a separate and distinct element within the mobile device 200, it will be apparent to those skilled in the art that the mobile wallet chip 280 functionality may be incorporated within other elements in the mobile device 200. For instance, the functionality of the mobile wallet chip 280 may be incorporated within the mobile device memory 220 and/or the processor 210. In a particular embodiment, the functionality of the mobile wallet chip 280 is incorporated in an element within the mobile device 200 that provides transaction completion capabilities to the mobile device 200. Moreover, the functionality may be part of the firmware of the mobile device 200. In some embodiments, the functionality is part of an application downloaded and installed on the mobile device 200. Still further, the mobile wallet chip 280 functionality may be included in a removable storage device such as an SD card or the like.

The processor 210 may be configured to use the network interface 260 to communicate with one or more other devices on a network 2. In this regard, the network interface 260 may include an antenna 276 operatively coupled to a transmitter 274 and a receiver 272 (together a “transceiver”). The processor 210 may be configured to provide signals to and receive signals from the transmitter 274 and receiver 272, respectively. The signals may include signaling information in accordance with the air interface standard of the applicable cellular system of the wireless telephone network that may be part of the network. In this regard, the mobile device 200 may be configured to operate with one or more air interface standards, communication protocols, modulation types, and access types. By way of illustration, the mobile device 200 may be configured to operate in accordance with any of a number of first, second, third, fourth-generation, fifth-generation, sixth-generation, or other like communication protocols, and/or the like. For example, the mobile device 300 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, with fifth-generation (5G) wireless communication protocols, and/or the like. The mobile device 200 may also be configured to operate in accordance with non-cellular communication mechanisms, such as via a wireless local area network (WLAN) or other communication/data networks.

The network interface 260 may also include a mobile wallet server interface 273 in order to allow a user 4 to execute transactions using the mobile wallet chip 280. The mobile wallet server interface 273 may have access to the hardware (e.g., the transceiver, and software previously described with respect to the network interface 260). Furthermore, the mobile wallet server interface 273 may have the ability to connect to and communicate with an external data storage on a separate system within the network, such as a server in the financial institution systems 30. In other embodiments of the invention, the network interface 260 may also include a wearable device interface 275 in order to allow a user 4 to send information to and receive information from the wearable device systems 20. The wearable device interface 275 may have access to the hardware (e.g., the transceiver, and software previously described with respect to the network interface 260). Furthermore, the wearable device interface 275 may have the ability to connect to and communicate with an external data storage on a separate system within the network 2, such as a server in the financial institution systems 30, third-party systems 40, and/or other systems (e.g., systems that control or received information from the wearable device systems 40).

As described above, the mobile device 200 may have a user interface that includes user output devices 236 and/or user input devices 240. The user output devices 236 may include a display 230 (e.g., a liquid crystal display (LCD) or the like) and a speaker 232 or other audio device, which are operatively coupled to the processor 210. The user input devices 240, which may allow the mobile device 200 to receive data from a user 210, may include any of a number of devices allowing the mobile device 200 to receive data from a user 210, such as a keypad, keyboard, touch-screen, display, touchpad, microphone, mouse, joystick, stylus, other pointer device, button, soft key, and/or other input device(s).

The mobile device 200 may further include a power source 215. Generally, the power source 215 is a device that supplies electrical energy to an electrical load. In one embodiment, power source 215 may convert a form of energy such as solar energy, chemical energy, mechanical energy, etc. to electrical energy. Generally, the power source 215 in the mobile device 200 may be a battery, such as a lithium battery, a nickel-metal hydride battery, or the like, that is used for powering various circuits (e.g., the transceiver circuit, and other devices that are used to operate the mobile device 200). Alternatively, the power source 215 may be a power adapter that can connect a power supply from a power outlet to the mobile device 200. In such embodiments, a power adapter may be classified as a power source “in” the mobile device.

The mobile device 200 may also include a memory 220 operatively coupled to the processor 210. As used herein, memory may include any computer readable medium configured to store data, code, or other information. The memory 220 may include volatile memory, such as volatile Random Access Memory (RAM) including a cache area for the temporary storage of data. The memory 220 may also include non-volatile memory, which can be embedded and/or may be removable. The non-volatile memory may additionally or alternatively include an electrically erasable programmable read-only memory (EEPROM), flash memory or the like.

The memory 220 may store any of a number of applications or programs which comprise computer-executable instructions/code executed by the processor 210 to implement the functions of the mobile device 200 described herein. For example, the memory 220 may include such applications as a wearable device system application 221 (e.g., at least a portion of the wearable device application 27 that is used to communicate with the wearable device, or other like application), a web browser application 222, an SMS application 223, an email application 224, etc.

Moreover, it should be understood that the wearable device systems 20 described herein may be another type of mobile device 200 (e.g., user computer system 10) described with respect to FIG. 2. As such, the wearable device systems 20 described herein may have the same or similar components as described with respect to the mobile 200 described with respect to FIG. 2. As such, the wearable device systems 20 may be capable of entering into transactions, monitoring the health of the user 4 through the use of sensors, and/or sending and receiving information to the various systems described herein.

FIG. 3 illustrates a process flow for monitoring user financial transactions, user health information, and retirement information for providing financial, health, and/or retirement feedback, in accordance with embodiments of the present invention. As illustrated by block 310 in FIG. 3, the systems described herein determine a projected life expectancy of the user 4. The determination of the life expectancy may be made based on user profile information stored by the financial institution in the financial institution systems 30, or otherwise determined by the third-party and provided to the financial institution. In one example, the user profile information may include the user's age, profession, geographic location, weight, height, medical history, or the like, which all may be utilized in calculating a life expectancy for the user 4. Moreover, the financial institution may have direct access to the financial transaction history of the user 4 or indirect access through accessing accounts with third-parties that the user 4 allows the financial institution to access. The financial institution may access the financial transaction history of the user 4 to determine the user's lifestyle, including but not limited to what the user eats, drinks, how much the user works out (e.g., gym membership, athletic gear transactions, or the like), how many vacations the user 4 takes, medication or medical issues the user 4 may have, or the like. In some embodiments, the user 4 may provide health information to the financial institution by answering questions related to the user's health, allowing the financial institution to access information related to the user's health, or providing or allowing the financial institution to access health information captured by a wearable device. The financial institution may also have, or have access to through a third-party, data and/or modeling software that provides life expectancy estimates based on the types of information described herein. As such, the financial institution may determine a projected life expectancy of the user 4 based on the information described herein.

As illustrated by block 320 in FIG. 3, the systems may be utilized to determine a projected allocation of funds for health expenses of the user 4. As previously discussed health expenses may include medical care expenses, fitness expenses, health food expenses, or the like. The medical care expenses may include co-pays, insurance premiums, medicine, medical procedures, medical equipment, or other like medical related costs that the user 4 may need in the future. The fitness expenses may include gym membership purchases, payments made to trainers, purchases of workout clothing and/or equipment, or other like fitness related costs. The health food expenses may include health food and drinks, supplements, vitamins, or other related health food expenses. In other embodiments of the invention the health food expenses may be rolled into medical expenses and/or fitness expenses.

The determination of the projected allocation of funds for health expenses may be made by a financial institution in various ways using various information sources. The financial institution may have information related to the desired retirement age of the user 4 and the amount of retirement funds the user 4 may have at such time based on the financial institution providing retirement planning services to the user 4. Additionally, the financial institution may utilize transaction information to determine what the user 4 has spent on health expenses in the past for medical care expenses, fitness expenses, health food expenses, or the like. Again, in some embodiments, the user 4 may provide health information to the financial institution by answering questions related to the user's health, allowing the financial institution to access information related to the user's health, and/or providing health expenses to the financial institution. Moreover, the financial institution may have access to retirement planning information that estimates the health expenses of other users that are similar to the user 4. For example, the financial institution may compare the user profile of the user 4 to other user profiles of other users (e.g., other customers) in order to determine suitable comparisons for the user 4. The financial institution may then average the health expenses previously described for the other users. As such, from the planned retirement age and the life expectancy of the user 4, as well as from the estimated health expenses provided or determined, the systems of the present invention may determine a projected allocation of finances for health care of the user 4 of the user in the future, for example during the user's retirement.

Block 330 of FIG. 3 illustrates that the financial, health, and retirement information, including the retirement age, the estimated available funds for retirement, the projected life expectancy of the user 4, and the projected allocation of funds for health care expenses of the user 4 during retirement, may be presented in a financial, health, and retirement user interface 400, as illustrated in FIG. 4. For example, the financial, health, and retirement user interface 400 may include a retirement summary section 402 with may include user profile information 404, the user age 405, the user's retirement age 406, the projected retirement funds 407, and the projected life expectancy 408. Moreover, the financial, health, and retirement user interface 400 may also include a retirement account section 410 and an estimated health expenses section 420. The retirement account section 410 may provide the actual and/or estimated future balances for the user's accounts at retirement, such as but not limited to the user's checking accounts 412, savings accounts 414, and/or retirements accounts 416 (e.g., the retirement account balances may be broken down into 401K, IRAs, self-directed investment accounts, annuity payments received, social security income, or other like retirement accounts). The estimated health expenses section 420 may illustrate the estimated total health expenses during retirement 422 (e.g., as a total, yearly, monthly, bi-weekly, weekly, or other like time period), as well as a breakdown of the total medical expenses 424, the total fitness expenses 426, and/or the total health food expenses 428. Each of these expenses may be further broken down into the components of each which were previously discussed herein.

As illustrated by block 340 in FIG. 3, the systems of the present invention may further monitor the financial transactions of the user using periodic downloads or real-time or near real-time monitoring. The systems may monitor the financial transactions that the user 4 enters into through accounts held or supported by the financial institution, or accounts with other financial institution that the user 4 allows the financial institution to access. Moreover, the user 4 may provide e-receipts, downloads transactions from credit cards, or provide other notifications of transactions to the financial institution for analysis. The financial institution may identify transactions that the user 4 enters into related to health expenses, which the financial institution my utilized to adjust the user's life expectancy or projected health expenses, as described in further detail below.

Block 350 of FIG. 3 further illustrates that the systems of the present invention may monitor the heath of the user 4 through periodic downloads of health information captured by the wearable device systems 20, and/or real-time or near real-time monitoring of the health information captured by the wearable device systems 20. The financial institution may receive health information from the wearable device system 20 and/or user computer systems 10 directly from the user 4, or through a third-party that the user 4 allows the financial institution to access or for which the financial institution has a partnership. The health information received from the wearable device systems 20 may allow the financial institution to adjust the user's life expectancy or projected health expenses allocations, as described in further detail below. In some embodiments information may be captured automatically using the user computer systems 10, wearable device systems 20, or the like, but in other embodiments the user 4 may enter (e.g., type, select, input, or the like) the health information on the user computer systems 10, wearable device systems 20, or the like). For example, a user 4 may type in or select what the user eats on a daily basis in order to determine the user's caloric intake.

FIG. 3 illustrates in block 360, that the projected life expectancy of the user 4 may be adjusted based on the financial transactions of the user 4 and/or the health information received that was captured by the wearable device systems 20. Block 370 further illustrates that in addition to the life expectancy being adjusted, the systems of the present invention also adjust the projected allocations of funds for health expenses of the user 4 based on the financial transactions and the information received that has been captured by the wearable device systems 20.

For example, if the user 4 changes purchasing habits for food from fast food and other unhealthy options to a more healthy diet the change in diet may be identified by monitoring the financial transactions of the user 4. As such, the systems of the present invention may recalculate and adjust the life expectancy of the user 4, such as increasing the life expectancy of the user 4. Moreover, this same change in the user's diet may also adjust the user's future health expenses. For example, as illustrated by the financial transaction health monitoring section 430 in the financial, health, and retirement monitoring interface 400, the user's transactions may be tracked for different transactions categories 432 and feedback related to the category costs 434, change in expenses 436 (e.g., change from a previous time period), change in future health expenses during retirement 438, change in life expectancy 440, and/or a description of the changes 442 may be presented to the user 4. The financial transaction health monitoring section 430 is illustrated as being tracked on a monthly basis, but in other embodiments of the invention individual single transactions may be tracked, or the transaction categories may be tracked on a daily, weekly, bi-weekly, monthly, multiple monthly, yearly, and/or other time period, and changes to the projected health expenses and/or life expectancy of the user 4 may be determined for any time period and displayed in the financial transaction health monitoring section 430 and/or the wearable device monitoring section 450 (discussed in further detail later). Returning to the change in diet, this process works in both directions, and as such the systems may lower the life expectancy of the user 4 and increase the projected health expenses of the user 4 if the user 4 begins to purchase more fast food and other unhealthy food options.

In other examples, the life expectancy of the user 4 may be increased if the user's financial transactions illustrate that the user 4 is working out, such as through gym membership purchases, payments made to trainers, purchases of workout clothing and/or equipment, or the like. Alternatively, if the user cancels a gym membership, trainer, or the like and the financial transactions indicate that the user 4 is participating in other exercise regimes, then the life expectancy may be reduced. As illustrated by the financial transaction health monitoring section 430 by tracking that the user 4 has joined a gym by monitoring the financial transactions of the user 4, the systems may determine that the user's change in life expectancy 440 has increased and the user's future health expenses during retirement 438 has decreased.

In other examples, if the financial transactions indicate that the user 4 is making additional purchases related to health expenses, such as medicines, medical equipment, or other medical expenses that indicate health issues, the life expectancy of the user 4 may be decreased, while the projected health expenses may be increased.

The information captured by the wearable device systems 20 may also help to adjust the life expectancy calculation and projected future health expenses made by the financial institution. For example, it may be determined on average that if the user takes 10,000 steps a day for a particular amount of time (e.g., years) the user may increase the user's life expectancy by a particular amount of time (e.g., years). For example, as illustrated by the wearable device monitoring section 450 in the financial, health, and retirement monitoring interface 400, the user's actions 452 may be tracked for a time period, and feedback related to the action results 454, change in the results 456 (e.g., change from a previous time period), change in future health expenses during retirement 458, change in life expectancy 460, and/or a description of the change in the action 462 may be presented to the user 4. As such, the wearable device monitoring section 450 may provide meaning information related to the data captured by the wearable device systems 20.

In other examples, if the wearable device system 20 indicates that the user 4 also is involved in strenuous exercise three (3) to four (4) times a week and is continued for years then the user's life expectancy may also be increased by a number of years. However, in other examples, the user 4 may exercise too much, and as such if the wearable device systems 20 capture that the user 4 undergoes strenuous activity seven (7) a week without a day or two of rest the user's life expectancy may decrease.

In other examples, the wearable device systems 20 may determine sleeping patterns related to how much the user 4 gets per night. For example, when a wearable band, or other wearable device system 20, is worn to bed at night the device may be able to determine how long the user 4 sleeps, how much of the sleep is deep sleep, how much of the sleep is light sleep, how often the user 4 wakes up, or the like. This information can be compared to the averages of other users, the life expectancy of other users, and data from studies that indicate how this information translates into life expectancy, and can be presented to the user to illustrate how the user's sleep not only affects the user's life expectancy, but also the projected health care expenses of the user 4.

In still other examples, as illustrated in the financial, health, and retirement interface 400, the sensor previously described herein may be used to determine the user's health, and as such adjust the user's life expectancy and/or projected future health expenses. For example, a sensor may determine the pulse and heart rate of the user at resting time and during exercise. This information captured from the sensors over time may be utilized to adjust the projected life expectancy of the user based on the pulse and heart rates of other users and the life expectancy of the other users over time. Other types of sensors may be utilized by or within the wearable device systems 20, as previously discussed, such as for example, sensors that may detect, predict, or analyze heart issues, strokes, dehydration, emotional state, proper exercise form, sweat analysis, body temperature, skin, brainwaves, or another type of diagnostic. These sensors monitoring a user 4 may provide information that can be used to adjust the life expectancy and/or the projected future health expenses of the user 4.

It should be understood that in some embodiments improving a user's health will result in lower health related expenses because the user 4 may not have as many medical health issues in the future; however, the fact that the user 4 may live longer by being more healthy may result in increased health expenses because the user 4 is projected to live longer.

As illustrated by block 380 the systems communicate the adjusted projected allocations of the funds for health expenses and the adjusted projected life expectancy of the user in a financial, health, and retirement interface 400 to the user 4 on a the user computer systems 10 and/or the wearable device systems 20. The projected allocations of funds for health expenses and the projected life expectancy may be displayed along with the user information, retirement account information, or the like over time, or for any time period, in order to illustrate how short and long term financial transactions related to the user's health and health information captured by wearable device systems 20 or otherwise received by the financial institution may affect the user's life expectancy and future health expenses.

In some embodiments, the financial institution may determine a suggested financial transaction or suggested health action to improve the user's life expectancy and/or the health expenses of the user 4. For example, with respect to suggested financial transactions the financial institution, through the systems described herein, may identify that the user 4 purchases too much fast food, does not have a gym membership, does not purchase athletic gear, and thus, make suggestions that could improve the user's life expectancy and/or reduce the user's estimated projected health expenses in the future. For example, the system may illustrate in the financial, health, and retirement interface 400 that if the user 4 substituted fast food meals for healthier meals and joined a gym the user 4 may increase the user's life expectancy by “X” percent and reduce the health expenses in the future by “Y” percent.

In other examples, the financial institution may determine from the wearable device system 20 health information indicating that the user 4 does not get enough sleep, for example, that if the user increase the user's amount of sleep from six (6) hours to between seven (7) and eight (8) hours of sleep a night, then the user's projected life expectancy increases by “X” number of years and/or the user's health expenses during retirement would decrease by “Y.” Moreover, the health information collected from the sensors on the wearable device may further be utilized to provide recommendations to the user 4 to improve the user's life expectancy and/or reduce the user's health expenses in the future. For example, the sensors may identify that the user 4 is dehydrated based on an analysis of the user's sweat, and the systems may provide a recommendation to drink more water and consume less salt. In other examples the systems may suggest to the user 2 to exercise more strenuously three times a week at a higher heart rate level, take more steps during the day, exercise more than three times a week for longer than one-half hour, take naps during the day to improve the user's mood, energy levels, or the like, improve the user's 4 diet based on analysis of the user's blood, skin, sweat, biometrics, or the like. This health information captured by the sensor of a wearable device system 20, and the subsequent analysis of the health information may be utilized to improve the user's life expectancy and/or reduce the user's health expenses in the future.

In some embodiments the present disclosure may be utilized to illustrate how the user's purchases are being paid for by the user 4 actively participating in a healthy lifestyle. For example, in some embodiment the user 4 may purchase a product, such as a good like health related equipment (e.g., a treadmill, workout equipment, juicer, or the like), or services (e.g. a personal trainer, gym membership, or the like) for a particular price. The price of the product and the type of product may be displayed to the user 4 in the financial, health, and retirement interface 400. Moreover, the financial, health, and retirement interface 400 may also display how the user 4 can receive a return on the product (e.g., meet or exceed the equivalent of the purchase price in health related cost savings) over time by illustrating how healthy transactions or use of the product over time can reduce user 4 expenses down the road. For example, if the user 4 purchases a treadmill, the system of the present invention may illustrate that if the user 4 utilizes the treadmill four times a week for 45 minutes, the user 4 may save “X” dollars on a monthly basis and save the equivalent of the purchase price of the treadmill within two years of using the treadmill (e.g., “paid off the purchase”). Moreover, if the user 4 continues to use the treadmill, the present invention can illustrate how the purchase of the product has actually made the user 4 money over time (e.g., “made money off of the product”).

In one embodiment of the invention, this information is displayed on the financial, health, and retirement interface 400 on a workout by workout basis and/or an aggregate basis. However, in other embodiments, this information may be presented to the user every time the user 4 utilizes the equipment and/or forgets to utilize the equipment. For example, the wearable device system 20 and/or the user computer system 10 may be able to identify the location of the user 4 as being near the user's treadmill (or other product) and determine that the user has exerted himself/herself for 45 minutes (or any other period of time). As such, the system of the present invention may send the user 4 a notification that the user just reduce the price of “X” (e.g., the purchased equipment), by a “Y” dollar amount (e.g., estimated amount of health expenses saved in the future); or otherwise, just “paid off X of the purchase price.” Moreover, in some embodiments, if the user 4 hasn't used the treadmill on a specific workout day, has only worked out 3 days within a week, or the like, then system may notify the user 4 that the user 4 missed a workout and the “paid off” amount of the product has not been increased. As such, the amount of time it would take for the user to “pay off” the product may be extended. In some embodiments these notifications (e.g., change in payoff price, reminder to use the product, or the like) are sent to the user 4 on the user computer systems 10 and/or the wearable device systems 20. Moreover, the change in the user's life expectancy and/or estimated health care expenses may also be presented to the user 4 through these notifications.

In some embodiments of the invention, the financial institution and/or a third party may provide offers of products to the users 4 based on the present invention. For example, the financial institution may have a partnership with a merchant (e.g., third party provider) that offers treadmills. Since the financial institution has access to the user's health related transactions and/or wearable device information, the merchant may offer the treadmill (and/or any other product) with personalized information related to the user 4 (e.g., workout schedule, health benefits, how the specific user can utilize the treadmill to “pay off” the treadmill or other product over time, or the like). As such, when a user 4 is offered a product by a merchant and/or the financial institution, the user 4 may also be presented how long it would take for the user 4 to save the equivalent of the cost of the treadmill or other product. The “pay off” time may be based on a general workout schedule or it may be based specifically on the user 4 himself/herself (e.g., based on the user's age, number of times the user works out, how long the user works out, what kind of exercise the user performs, how often the user 4 uses a similar product, or the like) which may or may not be determined from the user's wearable device system 20 and/or user computer systems 10 as described herein.

The present invention is utilized to illustrate how the user's choices affect the user's life expectancy, but also to illustrate though the financial, health, and retirement interface 400 that the user 4 can save money during retirement by making healthier choices. The user's choices individually may not have a great impact on the life expectancy and/or the health expenses of the user 4, but the present invention illustrates how the choices add up significantly over a time period.

The present invention was described with respect to monitoring the health expenses and health information captured for a user 4, but it should be understood that the health expenses and health information may be monitored for a group of people (e.g., workout group, family members, or the like). As such, the present disclosure described herein may also apply to a group users 4 for which the information described, captured, and displayed in the interfaces relates to a group of users 4 and/or an aggregate of users 4.

In accordance with embodiments of the invention, the term “module” with respect to a system may refer to a hardware component of the system, a software component of the system, or a component of the system that includes both hardware and software. As used herein, a module may include one or more modules, where each module may reside in separate pieces of hardware or software.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g. a memory) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

To supplement the present disclosure, this application further here incorporates by reference in their entirely the following commonly assigned patent applications:

| Docket Number | U.S. patent application Ser. No. | Title | Filed On |
|---|---|---|---|
| 6508US1.014033.2439 | | GENERATING A ONE-CLICK | Concurrently |
| | | FINANCIAL PLAN | Herewith |
| 6510US1.014033.2440 | | A SYSTEM FOR NETWORK | Concurrently |
| | | PAIRING OF INVESTORS AND | Herewith |
| | | ADVISORS BASED ON | |
| | | INVESTOR INFORMATION | |
| | | ANALYTICS | |
| 6514US1.014033.2441 | | AUTOMATED FUND | Concurrently |
| | | REALLOCATION BASED ON | Herewith |
| | | GOAL PROGRESS | |
| 6517US1.014033.2443 | | MODIFYING AN ESTIMATED | Concurrently |
| | | FINANCIAL PLAN | Herewith |
| 6518US1.014033.2444 | | GOAL GUARANTEE SYSTEM | Concurrently |
| | | | Herewith |

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. An integrated financial, health, and retirement monitoring system that utilizes health information captured by a wearable device and financial transaction information to provide retirement feedback to the user, the system comprising:
one or more memory devices; and
one or more processing devices operatively coupled to the one or more memory devices, wherein the one or more processing devices are configured to execute computer-readable program code to:
monitor the financial transactions of a user;
monitor health of the user by receiving the health information captured by the wearable device associated with the user;
determine a projected life expectancy of the user;
determine a projected allocation of heath expenses for the user based on the financial transactions monitored and the health information captured by the wearable device; and
display the projected life expectancy of the user and the projected allocation of the health expenses to the user in a financial, health, and retirement monitoring interface through a user computer system or through the wearable device.

2. The system of claim 1, wherein the one or more processing devices are further configured to execute computer-readable program code to:
receive a request from the user to utilize the financial, health, and retirement monitoring system;
determine an initial projected life expectancy of the user based on user profile information; and
determine an initial projected allocation of heath expenses of the user based on historical financial transactions.

3. The system of claim 1, wherein the financial transactions of the user are monitored in real-time or near real-time, and the health information is captured by the wearable device and received in real-time or near real-time.

4. The system of claim 1, wherein the one or more processing devices are further configured to execute computer-readable program code to:
determine a new retirement age and retirement funds based on the projected life expectancy of the user and the projected allocation of heath expenses for the user; and
display the new retirement age and the retirement funds to the user in the financial, health, and retirement monitoring interface.

5. The system of claim 1, wherein the one or more processing devices are further configured to execute computer-readable program code to:
determine a suggested financial transaction to improve the projected life expectancy of the user and the projected allocation of heath expenses for the user; and
display the suggested financial transaction to the user in the financial, health, and retirement interface.

6. The system of claim 1, wherein the one or more processing devices are further configured to execute computer-readable program code to:
determine a suggested action to improve the projected life expectancy of the user and the projected allocation of heath expenses of the user; and
display the suggested action to the user in the financial, health, and retirement monitoring interface.

7. The system of claim 1, wherein the financial, health, and retirement monitoring interface illustrates the change in health expenses and life expectancy per each transaction and action, per a category of transactions and actions, and as a total for all transactions and actions.

8. A computer program product for integrated financial, health, and retirement monitoring system that utilizes health information captured by a wearable device and financial transaction information to provide retirement feedback to the user, comprising at least one non-transitory computer-readable medium having computer-readable program code portions embodied therein, the computer-readable program code portions comprising:
an executable portion configured to monitor the financial transactions of a user;
an executable portion configured to monitor health of the user by receiving the health information captured by the wearable device associated with the user;
an executable portion configured to determine a projected life expectancy of the user;
an executable portion configured to determine a projected allocation of heath expenses for the user based on the financial transactions monitored and the health information captured by the wearable device; and
an executable portion configured to display the projected life expectancy of the user and the projected allocation of the health expenses to the user in a financial, health, and retirement monitoring interface through a user computer system or through the wearable device.

9. The computer program product of claim 8, wherein the computer-readable program code portions further comprise:
an executable portion configured to receive a request from the user to utilize the financial, health, and retirement monitoring system;
an executable portion configured to determine an initial projected life expectancy of the user based on user profile information; and
an executable portion configured to determine an initial projected allocation of heath expenses of the user based on historical financial transactions.

10. The computer program product of claim 8, wherein the financial transactions of the user are monitored in real-time or near real-time, and the health information is captured by the wearable device and received in real-time or near real-time.

11. The computer program product of claim 8, wherein the computer-readable program code portions further comprise:
an executable portion configured to determine a new retirement age and retirement funds based on the projected life expectancy of the user and the projected allocation of heath expenses for the user; and
an executable portion configured to display the new retirement age and the retirement funds to the user in the financial, health, and retirement monitoring interface.

12. The computer program product of claim 8, wherein the computer-readable program code portions further comprise:
an executable portion configured to determine a suggested financial transaction to improve the projected life expectancy of the user and the projected allocation of heath expenses for the user; and
an executable portion configured to display the suggested financial transaction to the user in the financial, health, and retirement interface.

13. The computer program product of claim 8, wherein the computer-readable program code portions further comprise:
an executable portion configured to determine a suggested action to improve the projected life expectancy of the user and the projected allocation of heath expenses of the user; and
an executable portion configured to display the suggested action to the user in the financial, health, and retirement monitoring interface.

14. The computer program product of claim 8, wherein the financial, health, and retirement monitoring interface illustrates the change in health expenses and life expectancy per each transaction and action, per a category of transactions and actions, and as a total for all transactions and actions.

15. A method for utilizing a financial, health, and retirement monitoring system to utilize health information captured by a wearable device and financial transaction information to provide retirement feedback to the user, the method comprising:
monitoring, by one or more processing devices, the financial transactions of a user;
monitoring, by the one or more processing devices, health of the user by receiving the health information captured by the wearable device associated with the user;
determining, by the one or more processing devices, a projected life expectancy of the user;
determining, by the one or more processing devices, a projected allocation of heath expenses for the user based on the financial transactions monitored and the health information captured by the wearable device; and
displaying, by the one or more processing devices, the projected life expectancy of the user and the projected allocation of the health expenses to the user in a financial, health, and retirement monitoring interface through a user computer system or through the wearable device.

16. The method of claim 15, further comprising:
receiving, by one or more processing devices, a request from the user to utilize the financial, health, and retirement monitoring system;
determining, by the one or more processing devices, an initial projected life expectancy of the user based on user profile information; and
determining, by the one or more processing devices, an initial projected allocation of heath expenses of the user based on historical financial transactions.

17. The method of claim 15, wherein the financial transactions of the user are monitored in real-time or near real-time, and the health information is captured by the wearable device and received in real-time or near real-time.

18. The method of claim 15, further comprising:
determining, by the one or more processing devices, a new retirement age and retirement funds based on the projected life expectancy of the user and the projected allocation of heath expenses for the user; and
displaying, by the one or more processing devices, the new retirement age and the retirement funds to the user in the financial, health, and retirement monitoring interface.

19. The method of claim 15, further comprising:
determining, by the one or more processing devices, a suggested financial transaction to improve the projected life expectancy of the user and the projected allocation of heath expenses for the user; and
displaying, by the one or more processing devices, the suggested financial transaction to the user in the financial, health, and retirement interface.

20. The method of claim 15, further comprising:
determining, by the one or more processing devices, a suggested action to improve the projected life expectancy of the user and the projected allocation of heath expenses of the user; and
displaying, by the one or more processing devices, the suggested action to the user in the financial, health, and retirement monitoring interface.

21. The method of claim 15, wherein the financial, health, and retirement monitoring interface illustrates the change in health expenses and life expectancy per each transaction and action, per a category of transactions and actions, and as a total for all transactions and actions.
